(19) United States
(12) Patent Application Publication
(10) Pub. No.: US 2012/0017715 A1
(43) Pub. Date: Jan. 26, 2012

(54) SELECTOR

(75) Inventors: Brian Bugeja, Crewe (GB); Thomas Burr, Melbourne (AU)

(73) Assignee: BENTLEY MOTORS LIMITED, Crew, Cheshire (GB)

(21) Appl. No.: 13/259,417

(22) PCT Filed: Mar. 31, 2010
(86) PCT No.: PCT/GB2010/050568

§ 371 Date: Sep. 23, 2011

(30) Foreign Application Priority Data
Apr. 3, 2009 (GB) 0905843.9

(51) Int. Cl. F16H 59/08

(52) U.S. Cl. 74/473.3

(57) ABSTRACT

A selector (1) may be displaced from a return position to make a selection from a number of available possibilities and then returned to the return position. The selector includes a display (3) operative to display an indication of a current selection at a position adjacent the return position. The selector may be an automotive automatic transmission selector. The display may display an indication of some or all of the available selections together, and the positions of the indications move relative to the return position as a selection is made, so that an indication of the chosen selection is displayed adjacent the return position.

The present invention relates to a selector with an associated display operative to show a selection mode. The invention relates particularly, although not exclusively, to an automotive automatic transmission selector.

Conventional automotive automatic transmissions have been provided with a selector lever to enable different modes of operation of the transmission to be selected. Usually these modes comprise Park, Reverse, Neutral and Drive. One or more additional modes may also be provided. With mechanically operated transmissions these tended to be lock out modes to prevent the transmission changing into one or more of the highest available ratios. With newer electronic or software controlled transmissions one or more programmed modes of operation may be available such as a ‘Sport’ or ‘Winter’ mode.

With a conventional mechanical transmission the selector is moved to a position corresponding to the desired mode of operation and each position is labelled according to the associated mode, for example as P R N D 3 2 1 to denote the lever positions for the selection of park, reverse, neutral, drive and various lock out positions where the number designates the highest permissible operating ratio of the transmission.

A driver can therefore easily see where to position the lever to select a desired mode of operation and can tell the selected mode at a glance. In addition, to aid the driver in low light conditions as well as generally it is known to arrange for the label indicating the selected mode, i.e. that which the selector lever is adjacent, to illuminate and/or change colour to further indicate the selection.

With the advent of electronic and software control of automatic transmissions there need only be an electrical link between a selector and the transmission, a so-called shift-by-wire arrangement. As the mechanical operation of the selector is independent of the mechanical operation of the transmission variations in selector operation have become possible.

One existing arrangement is a mono-stable selector lever. The lever is biassed towards a stable return position but can be displaced in opposite directions from the return position to select a desired mode of operation by sequentially indexing up or down a sequence of available modes. Because the mono-stable lever itself always returns to the same rest position it is not possible, unlike with multi-stable levers, to indicate a selected mode by the position of the selector lever.

It is an object of the present invention to address this problem.

According to an aspect of the present invention there is provided a selector which may be displaced from a return position to make a selection from a number of available possibilities and then returned to the return position, the selector comprising a display operative to display an indication of a current selection at a position adjacent the return position of the selector.

As the chosen selection is displayed adjacent the return position then, in normal operation, the selector is adjacent an indication of the chosen selection, rather than of any possible other selection.

Preferably the display is operative to display an indication of a plurality or all of the available selections together and the position of the indications is moved relative to the return position of the selector as a selection is made so that an indication of the chosen selection is displayed adjacent the return position.

The display may comprise an electronic or electrical display and in particular may comprise a display screen. Any suitable electrical or electronic display may be used for example an LCD, TFT or OLED display. The display may be illuminated. Alternatively the display may be mechanical in which case it may comprise a member, such as a strip or ribbon, bearing indications of available selections which is arranged to move on operation of the selector so that the chosen selection is displayed adjacent the return position of the selector.

According to another aspect of the present invention there is provided a selector which may be displaced from a return position to make a selection from a number of available possibilities and then returned to the return position, the selector comprising a display adjacent the selector indicating the available possibilities from which a selection can be made and arranged to highlight the current selection.

The following optional features may be combined with those of either aspect of the invention.

The selector may be an automatic transmission selector. In this case the selector is operable to select a mode of operation of the transmission from a range of available modes. These modes may include park, reverse, neutral and drive and one or more additional modes of operation. The display may be operable to indicate the selected mode of operation by display of a letter, numeral, or other symbol or indicia.

The display may be illuminated. The display may be arranged so that only an indication of the chosen selection is illuminated. Alternatively illumination of the indication of the chosen selection may be altered, such as by changing its colour, in order to highlight the chosen selection.

The selector may be a lever. The selector may be operable from a return position to sequentially index the chosen selection from a sequence of available selections. The selector may be operable to two selection positions to index the chosen selection up and down within a sequence of available selections. The selector may be mounted within a linear gate. The display may be elongate.

In order that the invention may be more dearly understood an embodiment thereof will now be described, by way of example, with reference to the accompanying drawings of which:

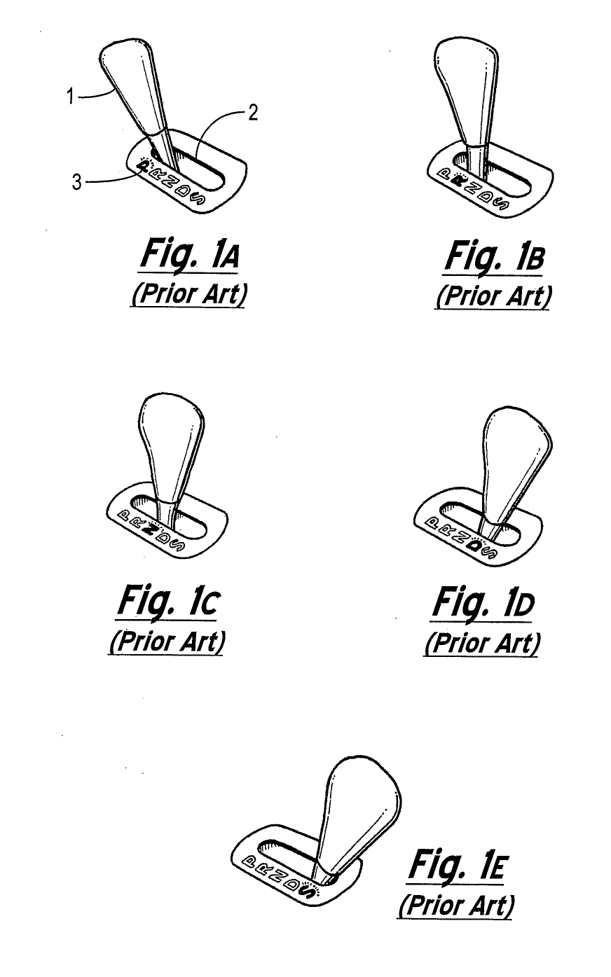

FIGS. 1A-E shows a number of views of a conventional type of automotive automatic transmission selector lever arrangement;

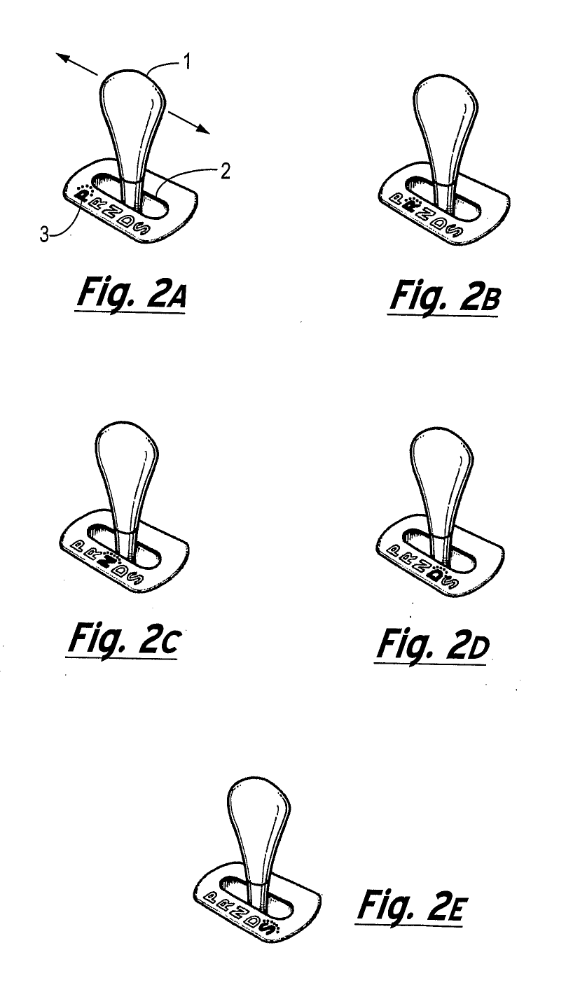

FIGS. 2A-E shows a number of views of an automotive automatic transmission selector lever arrangement according to the invention; and

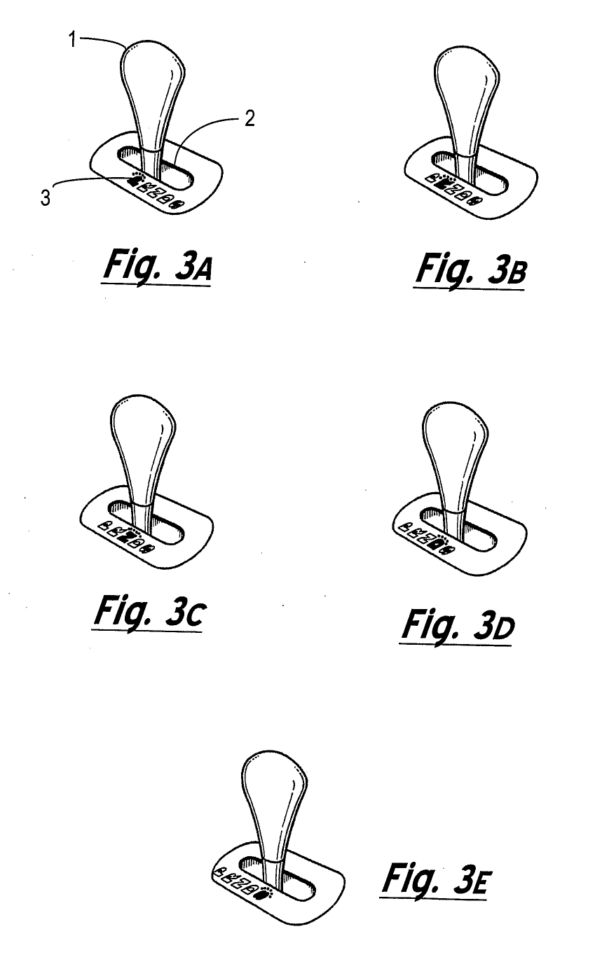

FIGS. 3A-E shows a number of views of another automotive automatic transmission selector lever arrangement according to the invention.

FIGS. 1A to 1E show a conventional multi-stable automatic transmission selection lever arrangement. The arrangement comprises a lever 1 which is movable between a plurality of positions within a linear gate 2. Alongside the gate is a sequence of letters, in this case P R N D S, indicating the mode of transmission operation which is selected by moving the lever 1 to a position adjacent the letter. The letters stand for park, reverse, neutral, drive and sport respectively. The letters remain in a fixed relationship relative to the gate. When the lever 1 is moved to a position adjacent a particular letter in order to select a desired mode of operation of the gearbox the letter adjacent which the lever is placed illuminates. FIGS. 1A to 1E respectively show the lever 1 in each of its possible operational positions. This arrangement is well known.

FIGS. 2A to 2E show a mono-stable automatic transmission selector lever arrangement according to the invention. This arrangement comprises a lever 1 operable in a linear gate 2 adjacent which are provided letters indicating the available modes of operation which can be selected, with the letter indicating the current selection illuminating. In contrast, however, to the arrangement illustrated in FIGS. 1A to E the lever 1 of this arrangement is biased to a central return position in which it lies adjacent the letter N. To select a desired operating mode a user displaces the lever 1 forwards or backwards within the gate against a return spring or other resiliently biased member, and then releases the lever allowing it to return to the return position. This causes the operating mode to be indexed one step up or down the available options. For example, as shown in FIG. 2A park mode is selected. To select reverse gear a user displaces the lever 1 backwards, that is towards the letters D and S away from the letter N, and releases the lever allowing it to return to the return position. This causes the transmission to select reverse mode and the letter R adjacent the gate 2 is illuminated. FIGS. 2A to 2E show selection of each available mode of operation. In each mode it will be noted that the lever 1 remains in the return position adjacent the letter N.

FIGS. 3A to 3E illustrate another automatic transmission selector lever arrangement according to the invention. There is a mono-stable lever 1 operable in a linear gate 2 adjacent which are displayed letters 3 denoting available modes of operation of the transmission, and with this arrangement the position of the displayed letters 3 is movable relative to the gate 2.

As with the selector arrangement of FIGS. 2A to 2E the lever is mono-stable type and returns to a central return position on release. Transmission mode selection is achieved by displacing the lever against a resilient bias either forwards or backwards within the gate 2 to index the selected mode of operation sequentially from the available modes. As a selection is made the displayed letters 3 move relative to the gate 2 so that the letter denoting the selected mode of operation lies adjacent the return position of the lever 1 so that the lever, when it returns to the return position, always lies adjacent the letter denoting the selected mode of operation. In addition, the letter denoting the selected mode of operation is illuminated or otherwise highlighted. This provides additional clarity as regards the selected mode as compared to the arrangement of FIGS. 2A-E. From a driver's point of view, the selected mode of operation can be more easily determined at a glance. The arrangement combines the flexibility of a mono-stable operation with the clarity of indication of current selection provided by the multi-stable arrangement such as illustrated in FIGS. 1A to 1E.

It will be appreciated that the moving letters 3 may be provided by any convenient means. in one arrangement an electronic display screen is provided adjacent the gate 2 such as an LCD, TFT or OLED display. In another arrangement the display is effected mechanically with physical movement of a strip or ribbon bearing the letters.

The above embodiment is described by way of example only. Many variations are possible without departing from the invention.

1. A selector arrangement comprising a selector which may be displaced from and then returned to a return position to make a selection from a number of available possibilities and a display operative to display indications of a plurality or all of the available possibilities together, wherein as a selection is made the displayed indications move relative to the return position of the selector so that the indication denoting the current selection lies adjacent the return position of the selector, and so that the selector, when returned to the return position, lies adjacent the indication denoting the current selection.

2. (canceled)

3. A selector arrangement as claimed in claim 1 wherein the display comprises an electronic or electrical display.

4. A selector arrangement as claimed in claim 1 wherein the display comprises a display screen.

5. A selector arrangement as claimed in claim 1 wherein the display is mechanical.

6. A selector arrangement as claimed in claim 5 comprising a member bearing indications of available selections which is arranged to move on operation of the selector so that the chosen selection is displayed adjacent the return position of the selector.

7. A selector arrangement as claimed in claim 1 wherein the display is arranged to highlight the indication denoting current selection.

8. A selector arrangement as claimed in claim 1 wherein the selector is an automatic transmission selector operable to select a mode of operation of the transmission from a range of available modes.

9. A selector arrangement as claimed in claim 1 wherein the display is illuminated and arranged so that so that only an indication of the chosen selection is illuminated.

10. A selector arrangement as claimed in claim 1 wherein the display is arranged so that the indication of the chosen selection is altered in order to highlight the chosen selection from the available selections.

11. A selector arrangement as claimed in claim 1 wherein the selector is operable from a return position to sequentially index the chosen selection from a sequence of available selections.

12. A selector arrangement as claimed in claim 1 wherein the selector is operable to two selection positions to index the chosen selection up and down within a sequence of available selections.

13. A selector arrangement as claimed in claim 1 mounted within a linear gate.

14. A selector arrangement as claimed in claim 1 wherein the display is elongate.

15. A selector arrangement as claimed in claim 1 wherein the selector is a mono-stable selector.
